(19) United States
(12) Patent Application Publication
(10) Pub. No.: US 2021/0173462 A1
(43) Pub. Date: Jun. 10, 2021

(54) SYSTEMS AND METHODS FOR ENHANCED POWER SYSTEM EVENT DETECTION AND IDENTIFICATION

(71) Applicant: General Electric Company, Schenectady, NY (US)

(72) Inventors: Weizhong Yan, Clifton Park, NY (US); Honggang Wang, Clifton Park, NY (US)

(21) Appl. No.: 16/707,399

(22) Filed: Dec. 9, 2019

(51) Int. Cl. G06F 1/28; G06F 16/28; G06N 20/00

(52) U.S. Cl. CPC G06F 1/28; G06N 20/00; G06F 16/285

(57) ABSTRACT

A computing device for detecting and identifying power system events is provided. The computing device includes at least one processor in communication with at least one memory device. The at least one processor is programmed to store a database including a plurality of categorized events. Each categorized event of the plurality of categorized events is associated with an event category. The at least one processor is also programmed to receive sensor data from a plurality of sensors monitoring a power grid, identify one or more features contained in the sensor data, compare the one or more features to the plurality of categorized events, and determine an event category based on the comparison.

### BACKGROUND

The field of the invention relates generally to power system event detection and identification, and more particularly, to a system for monitoring power systems and detecting and identifying power system events for uncommon events.

Power system events, such as generator trips, line outages, and oscillations, happen frequently. Those events, if not detected early so that proper actions may be taken, may potentially escalate to wide-area oscillations and even cause a blackout. Therefore, fast event detection, identification, and location are important to enhance the wide-area situational awareness of power systems and prevent cascading failures.

Event detection and identification requires significant knowledge of the event. Traditionally, the features of an event are defined by domain experts. A scarcity of event data prevents using advanced data driven techniques to detect and identify the events. Traditional knowledge-based and rule-based methods require strong domain knowledge. Furthermore, traditional methods may require significant amounts of time and effort, and are therefore, not scalable.

More comprehensive systems that can capture spatial temporal characteristics and that are detected and identified through advanced data-driven machine learning techniques are needed in order to achieve the desired performance for event detection, identification, and localization.

### BRIEF DESCRIPTION

In one aspect, a computing device for detecting and identifying power system events is provided. The computing device includes at least one processor in communication with at least one memory device. The least one processor is programmed to store a database including a plurality of categorized events. Each categorized event of the plurality of categorized events is associated with an event category. The at least one processor is also programmed to receive sensor data from a plurality of sensors monitoring a power grid. The at least one processor is further programmed to identify one or more features contained in the sensor data. Moreover, the at least one processor is programmed to compare the one or more features to the plurality of categorized events. In addition, the at least one processor is programmed to determine an event category based on the comparison.

In another aspect, a computing device for building a database of categorized events is provided. The computing device includes at least one processor in communication with at least one memory device. The at least one processor is programmed to store a database including a plurality of categorized events. Each categorized event of the plurality of categorized events is associated with an event category. The at least one processor is also programmed to receive an event. The at least one processor is further programmed to identify one or more features contained in the event. Moreover, the at least one processor is further programmed to compare the one or more features to the plurality of categorized events. In addition, the at least one processor is further programmed to determine an event category for the event based on the comparison.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 illustrates a block diagram of a power distribution grid.

FIG. 2 illustrates a high-level block diagram of a system for performing sequential calibration in accordance with some embodiments.

FIG. 3 illustrates a process for building an event detection and identification model for detecting and identifying events in the power distribution grid shown in FIG. 1, in accordance with one embodiment of the disclosure.

FIG. 4 illustrates a process for detecting and identifying events using the event detection model shown in FIG. 3 with the power distribution grid shown in FIG. 1 in accordance with some embodiments.

FIGS. 5A and 5B illustrate data flow diagrams of calculating feature-based similarity of events in accordance with at least one embodiment.

FIG. 6 illustrates a data flow diagram of feature-based event identification in accordance with at least one embodiment.

FIG. 7 is a simplified block diagram of an example system for detecting and identifying events on the power grid 100 shown in FIG. 1 using the processes shown in FIGS. 3 and 4.

FIG. 8 illustrates an example configuration of a client computer device shown in FIG. 7, in accordance with one embodiment of the present disclosure.

FIG. 9 illustrates an example configuration of the server system shown in FIG. 7, in accordance with one embodiment of the present disclosure.

### DETAILED DESCRIPTION

The systems and methods described herein are directed to identifying contributing factors (features) for power system events, such as generator trips, line outages, and oscillations. More specifically, the systems and methods disclosed herein include a data-driven, machine learning technique that uses real power system data (PMU, SCADA, etc.) to detect and identify features that identify the true contributing factors of the events. Such identified features can be used for event detection and identification and other early warning and operator decision support tools for enhancing the reliability and resiliency of the national power grid.

The advantages of this disclosure are primarily two-fold. First, for better capture of the complex spatial-temporal characteristics of events, the system uses advanced feature engineering techniques to generate a large number of sophisticated features. This is in opposition to the traditional approaches of using knowledge-based engineering features. Such feature-defined events will lead to better event detection and identification performance. Second, the disclosure includes a novel auto-associative modeling method to detect and identify the features for events with very a few samples.

Event identification using data-driven machine learning techniques can be treated as a feature selection problem, a well-studied machine learning topic. In the case where the number of samples for both normal and events are sufficient, there are numerous feature selection methods available, including filter approaches, wrapper approaches, and embedding approaches. However, in real-world power system operation, some events may be a rare occurrence, but have significant consequences. For those rare, but high impact events, event samples are generally very sparse. Effectively detecting and identifying their features (contributing factors) is both challenging and important at the same time.

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “power system devices” refers to devices that the simulation engine or simulation model represent may include: transmission systems, generating units, and loads. Transmission systems include, but are not limited to, transmission lines, power transformers, mechanically switched shunt capacitors and reactors, phase-shifting transformers, static VAR compensators (SVC), flexible AC transmission systems (FACTS), and high-voltage dc (HVDC) transmission systems. The models may include equipment controls such as voltage pick-up and drop-out levels for shunt reactive devices. Generating units include the entire spectrum of supply resources—hydro-, steam-, gas-, and geothermal generation along with rapidly emerging wind and solar power plants. The load represents the electrical load in the system, which range from simple light-bulbs to large industrial facilities.

As used herein, the term “Phasor Measurement Unit” (PMU) refers to a device used to estimate the magnitude and phase angle of an electrical phasor quantity (such as voltage or current) in the electricity grid using a common time source for synchronization. Time synchronization is usually provided by GPS and allows synchronized real-time measurements of multiple remote points on the grid. PMUs are capable of capturing samples from a waveform in quick succession and reconstructing the phasor quantity, made up of an angle measurement and a magnitude measurement. The resulting measurement is known as a synchrophasor. These time synchronized measurements are important because if the grid's supply and demand are not perfectly matched, frequency imbalances can cause stress on the grid, which is a potential cause for power outages.

PMUs may also be used to measure the frequency in the power grid. A typical commercial PMU may report measurements with very high temporal resolution in the order of 30-60 measurements per second. Engineers use this in analyzing dynamic events in the grid which is not possible with traditional SCADA measurements that generate one measurement every 2 or 4 seconds. Therefore, PMUs equip utilities with enhanced monitoring and control capabilities and are considered to be one of the most important measuring devices in the future of power systems. A PMU can be a dedicated device, or the PMU function can be incorporated into a protective relay or other device.

As used herein, the terms “power grid disturbance” and “power grid event” refer to outages, forced or unintended disconnection, or failed re-connection of breaker as a result of faults in the power grid. A grid disturbance starts with a primary fault and may also consist of one or more secondary faults or latent faults. A grid disturbance may, for example, be: a tripping of breaker because of lightning striking a line; a failed line connection when repairs or adjustments need to be carried out before the line can be connected to the network; an emergency disconnection due to fire; an undesired power transformer disconnection because of faults due to relay testing; and tripping with a successful high-speed automatic reclosing of a circuit breaker.

The feature of an event may include a peak value, a bottom value, an overshoot percentage, a rising time, a settling time, a delay time, a peak time, a steady state error, a phase shift, a damping ratio, an energy function, a cumulative deviation in energy, Fourier transformation spectrum information, a frequency response, a principal component, a minimum volume ellipsoid, and/or a steady state gain (P, Q, u, f), of the event. The feature is extracted from the time series of active power, reactive power, voltage, and frequency.

PMU recordings of almost any noticeable grid event can be used for event identification. During grid disturbances, a device operates outside of its normal steady-state condition, providing an opportunity to observe the dynamic behavior of the asset during transients. These transient disturbances often pose the most risk for grid stability and reliability. Some of the grid events that may generate valuable PMU data for model validation purposes include, but are not limited to:

Frequency excursion events—In a frequency excursion event, a substantial loss of load or generation causes a significant shift in electrical frequency, typically outside an interconnection's standard.

Voltage excursion events—A fault on the system, a significant change in load or generation (including intermittent renewables), or the loss of a significant load or generation asset can cause voltage shifts.

Device trips—Transmission devices and lines routinely trip out of service.

Remedial Action Scheme (RAS) activations—Useful data events for event detection and identification can be caused by a reaction to mitigate grid disturbances. Certain grid disturbances may cause a RAS activation, which will attempt to regulate the grid back to a normal operating condition. In some systems, the RAS may include switching on devices such as shunt reactors, changing FACTS devices, or inserting braking resistance. Activation of the RAS may create additional discrete disturbance events on the system, providing frequency and voltage events that can also be identified based on feature.

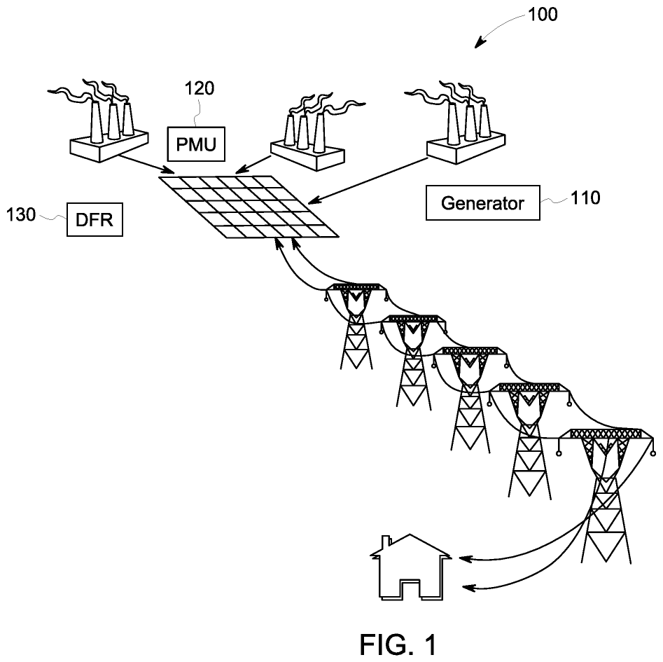

FIG. 1 illustrates a power distribution grid 100. The grid 100 includes a number of components, such as power generators 110. The components may include, but are not limited to, traditional generating plant, wind, solar, dynamic load, etc. The systems described herein consider not only active power (P) and reactive power (Q) but also voltage (U) and frequency (F). Recently, PMUs 120 and Digital Fault Recorders (“DFRs”) 130 have seen dramatic increasing installation in recent years, which may allow for non-invasive monitoring of the components of the grid 100 by using the sub-second-resolution dynamic data. Varying types of disturbances across locations in the grid 100 along with the large installed base of PMUs 120 may, according to some embodiments, make it possible to detect and identify events and the precursors to those events to allow for faster response to those events and potentially allow the events to be mitigated. There is a need for a system for detecting those events with speed and accuracy.

Online performance monitoring of power plants using synchrophasor data or other high-resolution disturbance monitoring data acts as a tool to ensure that the variables analyzed in event detection and identification match the actual output of the power plant or generating unit. From the Generator Owner (GO)'s perspective, online event detection and identification using high resolution measurement data can provide highly accurate event detection and identification, even for rare events. Online performance monitoring requires that disturbance monitoring equipment, such as a PMU, be located at the terminals of an individual generator or Point of Interconnection (POI) of a power plant.

The disturbance recorded by a PMU typically consists of four variables: voltage, frequency, active power, and reactive power. To use the PMU data for event detection and identification, an enhanced detection method has been developed. The features of events are categorized in an instance database and then compared to real-time data.

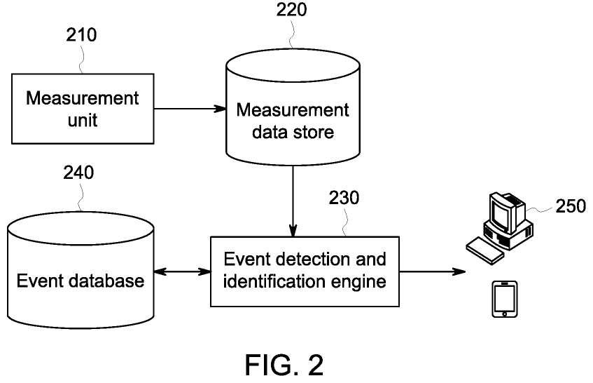

To achieve such results, FIG. 2 is a high-level block diagram of a system 200 in accordance with some embodiments. The system 200 includes one or more measurement units 210 (e.g., PMUs, DFRs, or other devices to measure frequency, voltage, current, or power phasors) that store information into a measurement data store 220. As used herein, the term “PMU” might refer to, for example, a device used to estimate the magnitude and phase angle of an electrical phasor quantity like voltage or current in an electricity grid using a common time source for synchronization. The term “DFR” might refer to, for example, an Intelligent Electronic Device (“TED”) that can be installed in a remote location, and that acts as a termination point for field contacts. According to some embodiments, the measurement data might be associated with disturbance event data and/or data from deliberately performed unit tests. According to some embodiments, an event detection and identification (EDI) engine 230 may access this data and use it to generate a database of potential events 240. The process is described herein. The real-time events might be detected automatically and reported to a remote operator interface device 250. As used herein, the term “automatically” may refer to, for example, actions that can be performed with little or no human intervention.

High-speed, time-synchronized data collected using PMUs may facilitate dynamic event detection and identification of grid events. Grid operators may use, for example, PMU data recorded during normal plant operations and grid events to respond to grid events models quickly and at lower cost. With an event detection and identification system that accurately reflects oscillations and their causes, the grid operator can also diagnose the causes of operating events, such as wind-driven oscillations, and identify appropriate corrective measures before those oscillations spread to harm other assets or cause a loss of load.

As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The event detection and identification engine 230 may store information into and/or retrieve information from various data stores, which may be locally stored or reside remote from the event detection and identification engine 230. Although a single event detection and identification engine 230 is shown in FIG. 2, any number of such devices may be included. Moreover, various devices described herein might be combined according to embodiments of the present invention. For example, in some embodiments, the measurement data store 220 and the event detection and identification engine 230 might be implemented as a single apparatus. The functions of system 200 may be performed by a constellation of networked apparatuses, such as in a distributed processing or cloud-based architecture.

A user may access the system 200 via the device 250 (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., when a new electrical power grid component is calibrated) and/or provide or receive automatically generated recommendations or results from the system 200.

The example embodiments provide an instance database for analyzing events. The instance database is initialized with a plurality of events and their corresponding event categories. The event categories include examples of the individual events. The instance database is trained by comparing it to a plurality of events with known event categories. For each event, the features of the event are calculated and compared to the features of the events stored in the instance database. Then, a similarity function is used to determine the similarity to between the events in the instance database and the received event. This is used to determine which event category (also known as event type) the event should belong in (i.e., which event category contains events with data closest to the actual received event). Then, the received event is assigned to the event category. In some embodiments, this category assignment is confirmed by a user. In the example embodiment, the event is added to the instance database as an event of the determined event category. This process repeats to train the instance database.

In the exemplary embodiment, the trained instance database is compared to real-time sensor data to detect and identify events in the sensor data. The features of the sensor data are calculated and compared to the features of the events in the instance database. A similarity function is used to determine the similarity between the events in the instance database and the received event. This is used to determine which event category the event should belong in (i.e., which event category contains events with data closest to the actual received event). Then, the received event is assigned to the event category. The event category may then be sent to a user and/or used to initiate an adjustment of the power grid.

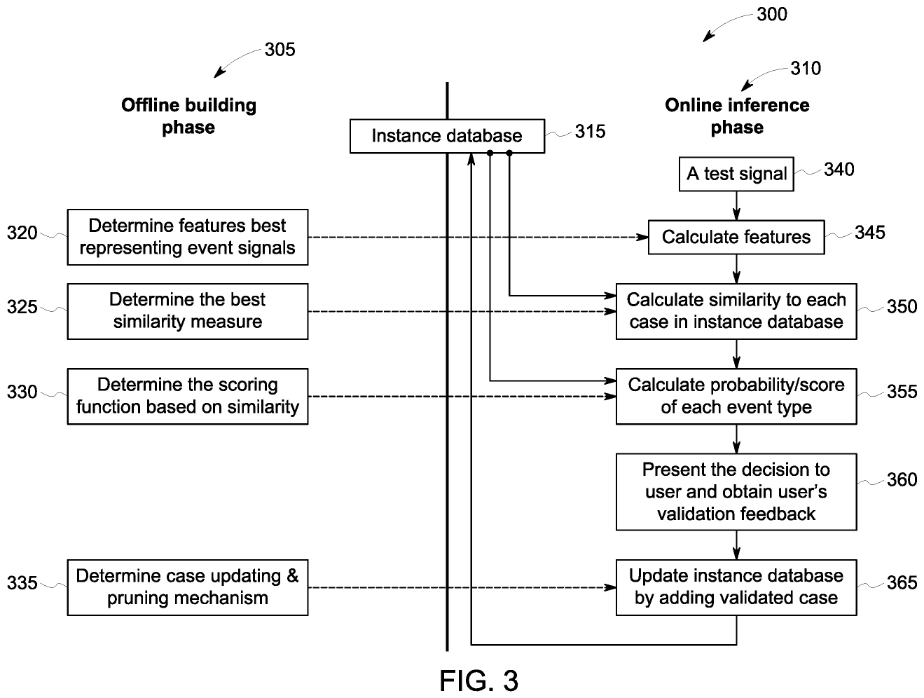

FIG. 3 illustrates a process 300 for building an event detection and identification model for detecting events in the power distribution grid 100 (shown in FIG. 1), in accordance with one embodiment of the disclosure. In the exemplary embodiment, the steps of process 300 are performed by an event detection and identification engine 230 (shown in FIG. 2). In the exemplary embodiment, process 300 includes an offline phase 305 and an online phase 310. In the exemplary embodiment, the offline phase 305 of process 300 includes preprocessing and analysis to prepare for the online phase 310.

For the purposes of this discussion, events are occurrences where the voltage and/or the frequency of the power system changes. For example, an event may be a generator turning on. In the exemplary embodiment, the event data or Phasor data will be imported from a variety of sources, such as, but not limited to, e-terraphasorpoint, openPDC, CSV files, COMTRADE files, and PI historian. In the exemplary embodiment, the events will have at least voltage, frequency, real power, and reactive power measurements. In some embodiments, voltage angle is substituted for frequency. The event data may include one or more of PMU data, SCADA data, event logs, and other grid related data to allow the system to detect and identify the event.

In the exemplary embodiment, event detection and identification engine 230 is in communication with an instance database 315 for storing information about the events. In some embodiments, the instance database 315 is similar to the event database 240 (shown in FIG. 2). In the exemplary embodiment, the instance database 315 stores a plurality of events, where each event is associated with an event category. In some embodiments, the events are pre-categorized by one or more users. The events may be categorized by subject matter experts or provided through literature, such as working papers. Each initial event stored in the instance database 315 includes a plurality of information about the variables that make up the event, such as the active power, reactive power, frequency, and voltage. Events may vary in length from a few seconds to a minute depending on the event and the corresponding data. In some situations, there may be multiple events in a single event category. In other situations there may be only a single event in an event category. In the exemplary embodiment, the instance database 315 stores a separate record for each event. In these embodiments, the record includes a unique identifier for the event, a signal for the event, and the event category. The signal may be, but is not limited to, multi-variate waveforms, data matrix, a 2D image, and a feature vector. In the exemplary embodiment, at least one of the events stored in the instance database 315 is associated with a normal operation event category to indicate normal operation of the power distribution grid 100.

In the exemplary embodiment, the event detection and identification engine 230 determines 320 the features of the event that best represent the associated event category. Examples of features include, but are not limited to, the range in a waveform between its lowest value and its highest value during an event, the width of change in the waveform illustrating how fast the signal ramps up or ramps down during the event, the mean value of the waveform, and the standard deviation of the waveform. These features may also apply to only a portion of the waveform of the event. The event detection and identification engine 230 uses feature generation to extract a set of salient features from the raw measurements, which best capture the underlying system behavior/characteristics (spatial-temporal relationships among the measurements). For feature generation, techniques from different technical domains, for example, knowledge-based, statistical-based, signal processing-based features, e.g., FFT, transformation-based, e.g., PCA, and learning-based, can be used. In some embodiments, feature generation gives two feature matrices, one for the normal data and another for the event data. In some embodiments, the event detection and identification engine 230 determines 320 the features for each event in the instance database 315. In other embodiments, the event detection and identification engine 230 determines 320 the features for each event category. In these embodiments, the event detection and identification engine 230 may analyze all of the events of each event category to determine 320 the features. For each event or event category, the determined features are stored in the instance database 315.

The event detection and identification engine 230 determines 325 the best similarity measure to use for each event or event category. Similarity measures are used to determine how similar the features of different events are. Similarity measures may include distance-based measures (e.g., Euclidean distance and Manhattan distance), statistical-based measures (e.g., correlation coefficient), and/or information-based measures (e.g., normalized information distance).

Other examples of similarity measures include but are not limited to:

Mean square errors (MSEs) or a mean squared deviation (MSD) of an estimator (e.g., of a procedure for estimating an unobserved quantity) may measure an average of the squares of errors—that is, the average squared difference between the estimated values and the actual value. MSE is a risk function, corresponding to the expected value of the squared error loss. The fact that MSE is almost always strictly positive (and not zero) is because of randomness or because the estimator does not account for information that could produce a more accurate estimate, for example.

A Manhattan distance includes a distance between two points measured along axes at right angles. A sum of absolute errors (SAE) comprises a sum of the absolute values of the vertical “residuals” between points generated by a function and corresponding points in the data.

A short time series (STS) distance may comprise a square of the gradient distance between two time series data, for example.

Cosine similarity refers to a measure of similarity between two non-zero vectors of an inner product space that measures the cosine of the angle between them. The cosine of 0° is 1, and is less than 1 for any angle in the interval (0, π] radians. A cosine similarity is thus a judgment of orientation and not magnitude: two vectors with the same orientation have a cosine similarity of 1, two vectors oriented at 90° relative to each other have a similarity of 0, and two vectors diametrically opposed have a similarity of −1, independent of their magnitude.

A correlation coefficient may comprise a numerical measure of some type of correlation, representing a statistical relationship between two variables. The variables may include two columns of a given data set of observations, e.g., a “sample,” or two components of a multivariate random variable with a known distribution, for example.

Dynamic time warping (DTW) may include an algorithm for measuring similarity between two temporal sequences which may vary in speed. For instance, similarities in walking could be detected using DTW, even if one person was walking faster than the other, or if there were accelerations and decelerations during the course of an observation.

Those having skill in the art will appreciate that other similarity measures may be used with the disclosure described herein. In the exemplary embodiment, the event detection and identification engine 230 determines 325 which of the available similarity measures are the best to use for comparing the features of each event category. This information is stored with the event category, such as in the instance database 315.

In the exemplary embodiment, the event detection and identification engine 230 determines 330 a scoring function for rating events based on the results of the similarity measure. During the online phase 310, the event detection and identification engine 230 uses the scoring function to determine in which event category to place an event based on the similarity measures of each event category to the event. In some embodiments, the scoring function is configured to assign a number between 0 and 1 to the event based on the likelihood or probability that the event fits into a specific event category.

In the exemplary embodiment, the event detection and identification engine 230 determines 335 a case updating and pruning mechanism. The case updating and pruning mechanism 335 allows the event detection and identification engine 230 to add and remove events from the instance database 315. In these embodiments, the event detection and identification engine 230 may add an event to the instance database 315 based on the event fitting well into an event category. The event detection and identification engine 230 may remove one or more events from an event category to reduce the number of events to be compared to. In some embodiments, the event detection and identification engine 230 removes events that are very similar to other events in the same event category to reduce duplication. In some embodiments, the event detection and identification engine 230 is configured to limit the instance database 315 to a maximum of 20 to 30 events per event category.

In the online phase 310, the event detection and identification engine 230 is configured to receive individual events 340. In some embodiments, the individual events 340 are provided by the measurement data store 220. In other embodiments, the individual events 340 are provided by the user device 250 (shown in FIG. 2).

In the exemplary embodiment, the event detection and identification engine 230 calculates 345 features that appear in the events 340. The event detection and identification engine 230 compares the features of the event 340 to the features of the plurality of events stored in the instance database 315. The event detection and identification engine 230 calculates 350 the similarity of each event 340 to each of the plurality of events in the instance database 315. Based on the calculated similarities, the event detection and identification engine 230 calculates 355 a probability or score for the event 340 belonging to each event category.

In some embodiments, the event detection and identification engine 230 presents 360 the user with a suggested event category. In other embodiments, the event detection and identification engine 230 presents 360 the user with a list of proposed event categories and the corresponding probabilities or scores. The user may confirm or override the suggested event category. In some embodiments, the event detection and identification engine 230 is training the instance database 315. In these embodiments, the event 340 already includes an event category. In these embodiments, the event detection and identification engine 230 compares the event category determined by the event detection and identification engine 230 to the actual event category. In some further embodiments, the event detection and identification engine 230 may adjust one or more scoring functions based on the comparison.

In the exemplary embodiment, the event detection and identification engine 230 updates 365 the instance database 315 with the event 340 in the determined event category. In some embodiments, the event detection and identification engine 230 replaces an event in the instance database 315 with the new event 340. In other embodiments, the event detection and identification engine 230 determines not to update 365 the instance database 315 with the new event 340.

In the exemplary embodiment, the event detection and identification engine 230 analyzes the new event 340 to determine whether or not to add the new event A 340 to the instance database 315. The event detection and identification engine 230 determines the number of instances of an event with the same event type as event A 340 in the instance database 315. If the number is less than a predetermined threshold, event A 340 is directly added into the instance database 315.

Otherwise, the event detection and identification engine 230 calculates an importance score for event A 340 and all events of that event type in the instance database 315. In the exemplary embodiment, the importance score is calculated based on several factors including, but not limited to: the confidence level of the event instance (which indicates how confident a labeled event is when domain experts label the event), the quality of the signal of the event instance (indicating if the signal has missing and/or noisy values), and the uniqueness of the event instance (indicating how different the event instances is from the rest of the instances of the same event type). In some embodiments, the uniqueness may be calculated as the inverse proportional to the distance to the nearest neighbor instance calculated in feature space.

The event detection and identification engine 230 compares the importance score for event A 340 to the other events of the same type in the instance database 315. If the importance score of event A 340 is greater than the event with the lowest importance score in the instance database 315, the event detection and identification engine 230 replaces the event with the lowest importance with event A 340 in the instance database 315. Otherwise, event A 340 is not added to the instance database. In some embodiments, a user, such as a domain expert, may override the algorithmic decision by manually adding or deleting events from the instance database 315.

In the exemplary embodiment, the event detection and identification engine 230 repeats Steps 345-365 for a plurality of events 340 to train the instance database 315 with a plurality of events in event categories.

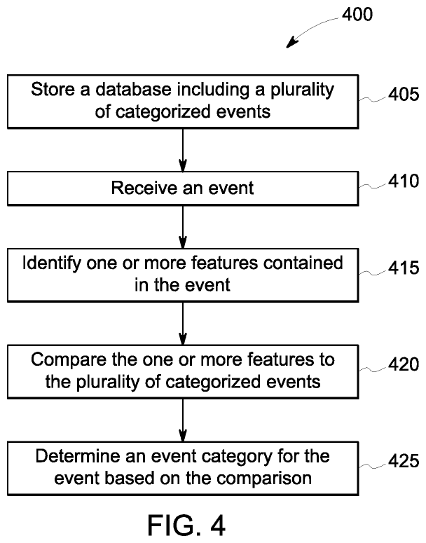

FIG. 4 illustrates a process 400 for detecting events using the event detection model shown in FIG. 3 with the power distribution grid 100 (shown in FIG. 1) in accordance with some embodiments. In the exemplary embodiment, process 400 is performed by event detection and identification engine 230 (shown in FIG. 2).

In the exemplary embodiment, the event detection and identification engine 230 stores 405 a database 315 (shown in FIG. 3) including a plurality of categorized events. Each categorized event in the plurality of categorized events is associated with an event category.

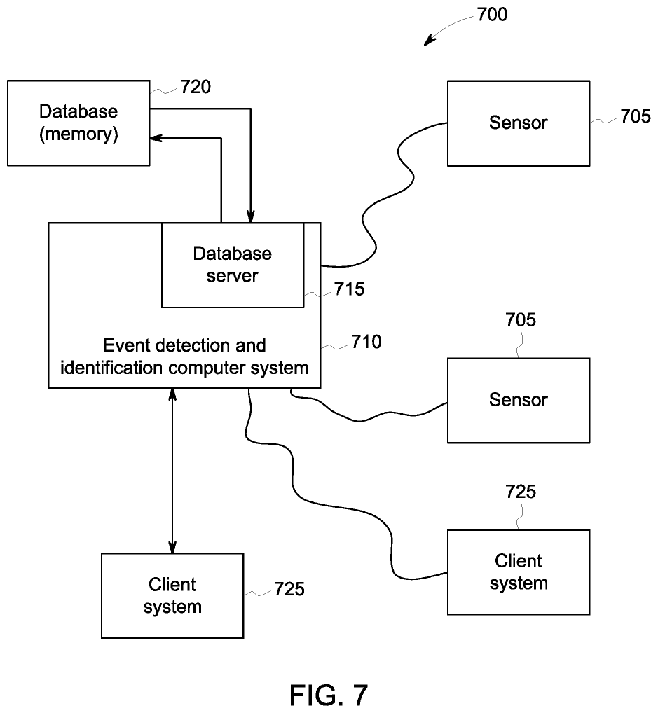

In the exemplary embodiment, the event detection and identification engine 230 receives 410 sensor data from a plurality of sensors 210 (shown in FIG. 2) monitoring a power grid 100. In some embodiments, the sensor data is received in real-time, from measurement units 210, the measurement data store 220, and/or sensors 705 (shown in FIG. 7). The sensor data includes at least one of active power, reactive power, voltage, frequency, and phase angle.

In the exemplary embodiment, the event detection and identification engine 230 identifies 415 one or more features contained in the sensor data. In the exemplary embodiment, the event detection and identification engine 230 compares 420 the one or more features to the plurality of categorized events. In the exemplary embodiment, each categorized event in the plurality of categorized events includes one or more features. The event detection and identification engine 230 compares the one or more features of each categorized event to the one or more features of the sensor data.

In some embodiments, the event detection and identification engine 230 calculates a similarity value for each categorized event in comparison to the received sensor data. In these embodiments, the similarity value is calculated based on how closely the features of the sensor data compares to the features of the plurality of categorized events. For each event category, the event detection and identification engine 230 calculates a probability that the received sensor data is associated with the corresponding event category.

In the exemplary embodiment, the event detection and identification engine 230 determines 425 an event category based on the comparison. In some embodiments, the event detection and identification engine 230 determines 425 that the sensor data is most similar to a specific event of a first event category, and then the event detection and identification engine 230 categorizes the sensor data as the first event category.

In the exemplary embodiment, the event detection and identification engine 230 adjusts operation of the power grid 100 based on the determined event category. For example, if the sensor data indicates that a specific event is about occur, then the event detection and identification engine 230 informs a user about the event or transmits one or messages to instruct other computer devices about the event, where the other computer devices may adjust the operation of the power grid 100.

In some embodiments, the event detection and identification engine 230 determines whether or not to add the received sensor data to the database 315 as a categorized event using the update process 365 described above in FIG. 3.

As used herein, the key to instance-based learning is using an effective method to analytically compare (aka calculate the similarity between two data instances.

The data of the events provided may include multiple, heterogeneous time series measurements from different sensors. A data instance in this case is either a multivariate time series data representing a known power system event or multivariate time series data whose event is to be identified. Comparing or calculating the similarity between two such data instances is challenging. Firstly, the two data instances on which the similarity is calculated can have different lengths (or number of samples) and even potentially have different number of sensors. More importantly, the data instances include strong temporal-spatial dependence and thus requiring taking into account such temporal-spatial dependence in comparing data instances.

To find out how similar of two multimodal time-series data instances are, one can simply calculate the similarities between all univariate time-series. The length difference between those univariate time-series may be addressed by using, for example, dynamic time warping. One problem with this method is that it fails to capture spatial relationships among those individual time-series.

To consider temporal-spatial dependence of the multimodal time-series data in comparing two data instance, the system 300 transforms the data instances to a common set of features. This transformation and comparison of features is shown in Steps 320 and 345 (both shown in FIG. 3) and also in Step 415.

The features comprise univariate-based and multivariate-based features. Univariate-based features include time-domain, frequency domain and time-frequency domain features. Time-domain statistical descriptors, e.g., min, max, mean, standard deviation, range, kurtosis, skewness, are most frequently used univariate-based features. Time-domain features may also include, but is not limited to, time-series analysis, signal processing, information theory, and morphological. Frequency domain features may include signal to noise ratio, total harmonic distortion, power bandwidth, band power, mean frequency, median frequency, frequency-response functions for modal analysis of the data series. Time-frequency features may include spectral entropy of the data series, joint moment of the time-frequency distribution of the data series, conditional spectral moment of the time-frequency distribution of the data series and conditional temporal moment of the time-frequency distribution of the data series. Examples of multivariate features include, but are not limited to, correlation, projection (principal component analysis (PCA) and independent component analysis (ICA)), and regression modeling.

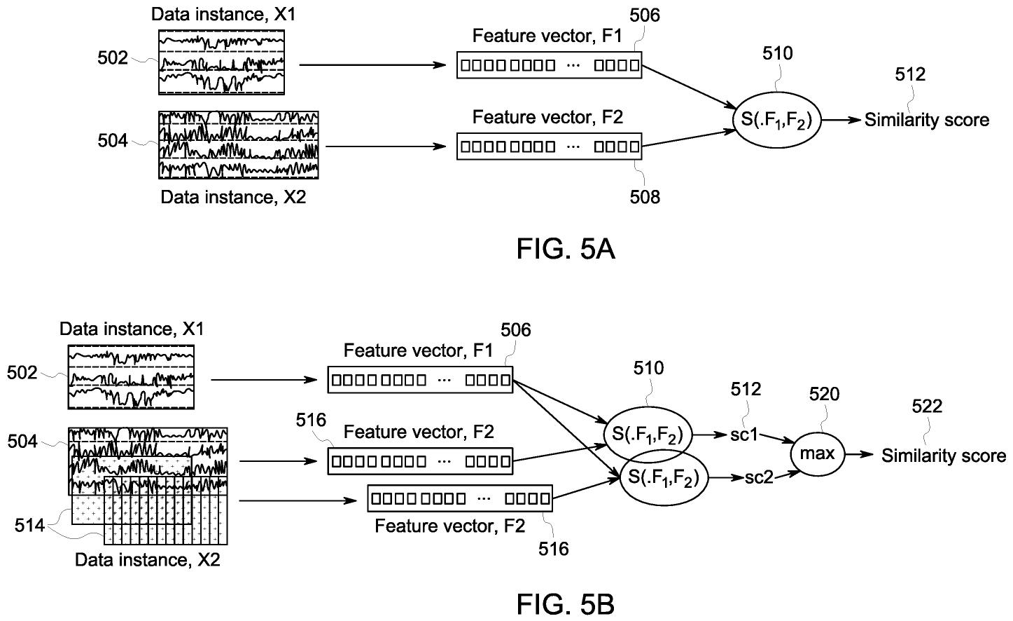

FIGS. 5A and 5B illustrate data flow diagrams of calculating feature-based similarity of events in accordance with at least one embodiment. In the exemplary embodiment, the event detection and identification engine 230 (shown I FIG. 2) calculates 345 the features of an event 340 and calculates 350 a similarity to each case in the instance database 315 (all shown in FIG. 3). In at least one embodiment, the event detection and identification engine 230 compares two events by comparing the features to determine the similarity score.

For example, data instance X1 502 is a first event to compare, such as new event 340. Data instance X2 504 is an event instance from the instance database 315. In FIG. 5A, data instance X1 502 is of a similar length to data instance X2 504. In FIG. 5B, data instance X1 502 is of a substantially smaller length than data instance X2 504.

Referring to FIG. 5A, features may be calculated on the entire length of data instance if the lengths for the two instances are close enough. In FIG. 5A, the event detection and identification engine 230 determines a feature vector F1 506 for data instance X1 502 and a separate feature vector F2 508 for data instance X2 504. The event detection and identification engine 230 uses a similarity score function 510 to calculate a similarity score 512 for the comparison of feature vector F1 506 and F2 508. In some embodiments, the event detection and identification engine 230 generates feature vectors for all of the events in the instance database 315.

Referring to FIG. 5B, data instances with more samples can be split into multiple (overlapping or disjoint) windows, and features are calculated on each of the multiple windows. The final similarity score takes the maximum value of these individual similarity scores (bottom chart). In FIG. 5B, data instance X2 504 is significantly larger than data instance X1 502. Therefore, event detection and identification engine 230 divides data instance X2 504 into multiple sections 514 or windows 514 the same size or similar in size to data instance X1 502. The event detection and identification engine 230 generates a feature vector F2 516 for each of the windows 514. The event detection and identification engine 230 then compares feature vector F1 506 to each of the feature vectors F2 516 using the similarity function 510. The event detection and identification engine 230 compares the similarity scores 512 generated for each comparison and determines the maximum 520 to determine which window 514 is most similar to data instance 502 and determine its corresponding similarity score 522.

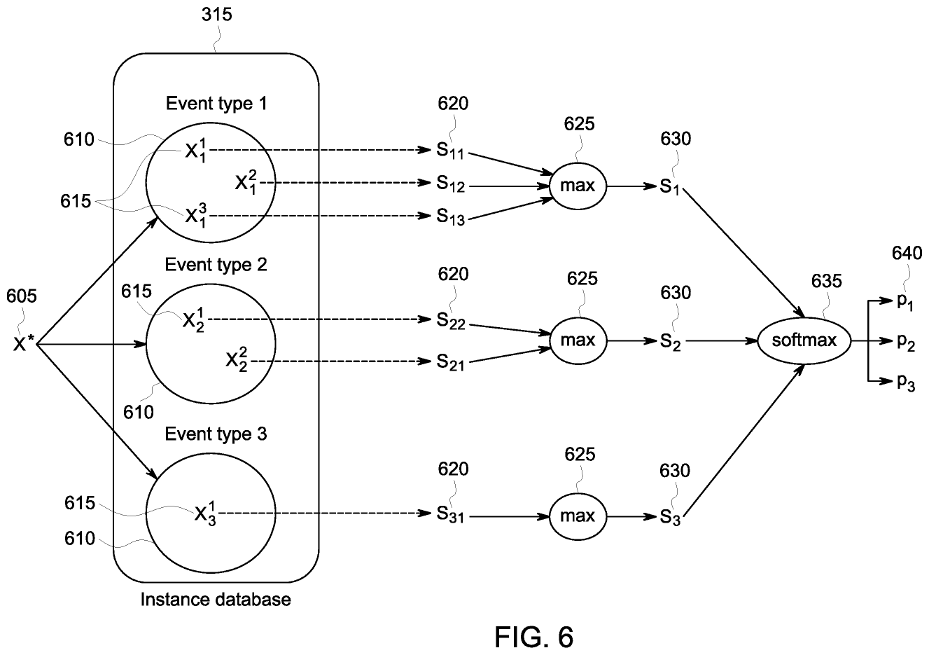

FIG. 6 illustrates a data flow diagram of feature-based event identification in accordance with at least one embodiment. FIG. 6 illustrates the process of comparing an event to the plurality of categorized events described in Steps 350 and 355 (both shown in FIG. 3) and in Step 420 (shown in FIG. 4).

In the exemplary embodiment, the event detection and identification engine 230 receives an event 605 to analyze. The event detection and identification engine 230 compares the received event 605 to a plurality of other events 615, where each event 615 is in an event type 610 and stored in the instance database 315. For each event 615 in each event type 610 in the instance database 315, the event detection and identification engine 230 determines a similarity score 620 for the comparison of that event 615 and the received event 605. The event detection and identification engine 230 determines 625 the comparison with the maximum similarity score 630 for each event type 610. Then the event detection and identification engine 230 compares 635 the maximum similarity score 630 from each event type 610 to determine the probabilities 640 that the event 605 belongs to the corresponding event type 610. One example for comparison 635 is a “softmax function” or “normalized exponential function,” which takes the multiple similarity scores 630, and normalizes them into a probability distribution consisting of multiple probabilities proportional to the exponentials of the input numbers. The softmax function is defined as follows:

$${p}_{i} = \frac{{e}^{{s}_{i}}}{{\sum }_{i = 1}^{n} {e}^{{s}_{i}}}$$

wherein the n is the total number of event types, sᵢ represents the similarity scores between the received event 605 and the event type i in the stored database. Each pᵢ is the probability of the event instance 605 belonging to i^{th} event type 610. FIG. 7 is a simplified block diagram of an example system 700 for detecting and identifying events on the power grid 100 (shown in FIG. 1) using the processes 300 and 400 (shown in FIGS. 3 and 4). In the example embodiment, the system 700 is used for analyzing and categorizing events occurring during operation of the power grid 100. In addition, the system 700 is a real-time event analyzing and categorizing computer system that includes an event detection and identification computer device 710 (also known as an event detection and identification server) configured to analyze and categorize events.

Sensors 705 observe the power grid 100 and components 110 (shown in FIG. 1) in real-time. More specifically, a sensor 705 measures a measured attribute of the observed device or system and is in communication with an event detection and identification computer device 710. The sensor 705 connects to event detection and identification computer device 710 through various wired or wireless interfaces including without limitation a network, such as a local area network (LAN) or a wide area network (WAN), dial-in-connections, cable modems, Internet connection, wireless, and special high-speed Integrated Services Digital Network (ISDN) lines. The sensor 705 receives data about conditions of an observed device or system and reports those conditions to event detection and identification computer device 710. In other embodiments, the sensors 705 are in communication with one or more client systems 725 and the client systems 725 route the sensor data to the event detection and identification computer device 710. In some embodiments, the sensors 705 are similar to a PMU 120, DFR 130 (both shown in FIG. 1), and measurement unit 210 (shown in FIG. 2). In other embodiments, the sensors 705 obtain data from a PMU 120 or DFR 130. In some embodiments, the sensors 705 measures one or more of V, f, P, and Q.

As described below in more detail, the event detection and identification server 710 is programmed to analyze data for potential events to allow the system 700 to respond to the event quickly. The event detection and identification server 710 is programmed to a) store a database including a plurality of categorized events, wherein each categorized event in the plurality of categorized events is associated with an event category; b) receive sensor data from a plurality of sensors monitoring a power grid; c) identify one or more features contained in the sensor data; d) compare the one or more features to the plurality of categorized events; and e) determine an event category based on the comparison.

In the example embodiment, client systems 725 are computers that include a web browser or a software application, which enables the client systems 725 to communicate with event detection and identification server 710 using the Internet, a local area network (LAN), or a wide area network (WAN). In some embodiments, the client systems 725 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. The client systems 725 can be any device capable of accessing a network, such as the Internet, including, but not limited to, a desktop computer, a laptop computer, a personal digital assistant (PDA), a cellular phone, a smartphone, a tablet, a phablet, or other web-based connectable equipment. In some embodiments, the client systems 725 are similar to the user device 250 (shown in FIG. 2).

A database server 715 is communicatively coupled to a database 720 that stores data. In one embodiment, the database 720 is a database that includes categorized events, feature data, and uncategorized events. In some embodiments, the database 720 is similar to the measurement data store 220, the event database 240 (both shown in FIG. 2), and the instance database 315 (shown in FIG. 3).

In some embodiments, the database 720 is stored remotely from the event detection and identification server 710. In some embodiments, the database 720 is decentralized. In the example embodiment, a person can access the database 720 via the client systems 725 by logging onto the event detection and identification server 710.

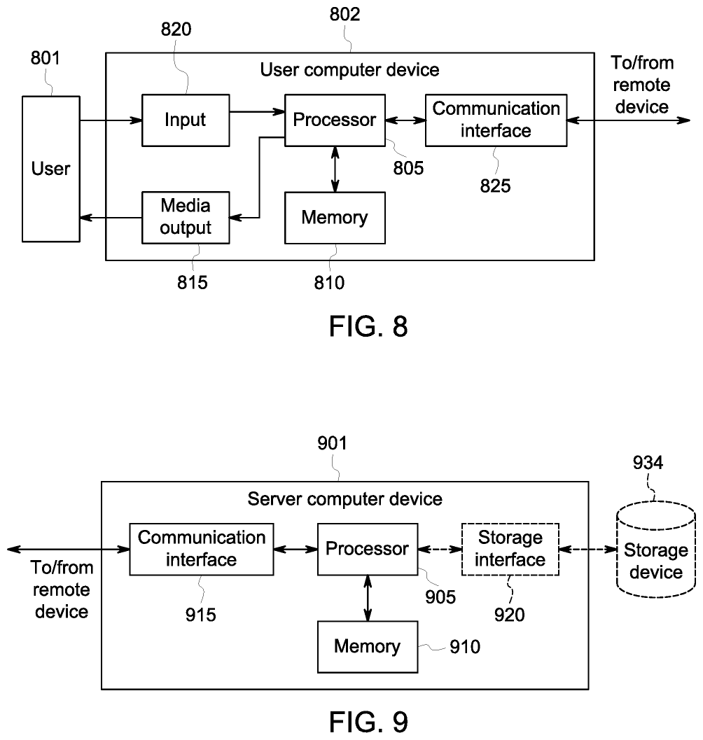

FIG. 8 illustrates an example configuration of the client system 725 shown in FIG. 7, in accordance with one embodiment of the present disclosure. A user computer device 802 is operated by a user 801. The user computer device 802 may include, but is not limited to, the user device 250 (shown in FIG. 2), the sensors 705, and the client systems 725 (both shown in FIG. 7). The user computer device 802 includes a processor 805 for executing instructions. In some embodiments, executable instructions are stored in a memory area 810. The processor 805 may include one or more processing units (e.g., in a multi-core configuration). The memory area 810 is any device allowing information such as executable instructions and/or transaction data to be stored and retrieved. The memory area 810 may include one or more computer-readable media.

The user computer device 802 also includes at least one media output component 815 for presenting information to the user 801. The media output component 815 is any component capable of conveying information to the user 801. In some embodiments, the media output component 815 includes an output adapter (not shown) such as a video adapter and/or an audio adapter. An output adapter is operatively coupled to the processor 805 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, the media output component 815 is configured to present a graphical user interface (e.g., a web browser and/or a client application) to the user 801. A graphical user interface may include, for example, an interface for viewing the results of the analysis of one or more events. In some embodiments, the user computer device 802 includes an input device 820 for receiving input from the user 801. The user 801 may use the input device 820 to, without limitation, select a computer system to view the analysis of. The input device 820 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of the media output component 815 and the input device 820.

The user computer device 802 may also include a communication interface 825, communicatively coupled to a remote device such as event detection and identification server 710 (shown in FIG. 7). The communication interface 825 may include, for example, a wired or wireless network adapter and/or a wireless data transceiver for use with a mobile telecommunications network.

Stored in the memory area 810 are, for example, computer-readable instructions for providing a user interface to the user 801 via the media output component 815 and, optionally, receiving and processing input from the input device 820. A user interface may include, among other possibilities, a web browser and/or a client application. Web browsers enable users, such as the user 801, to display and interact with media and other information typically embedded on a web page or a website from the event detection and identification server 710. A client application allows the user 801 to interact with, for example, the event detection and identification server 710. For example, instructions may be stored by a cloud service, and the output of the execution of the instructions sent to the media output component 815.

The processor 805 executes computer-executable instructions for implementing aspects of the disclosure. In some embodiments, the processor 805 is transformed into a special purpose microprocessor by executing computer-executable instructions or by otherwise being programmed.

FIG. 9 illustrates an example configuration of the server system 710 (shown in FIG. 7), in accordance with one embodiment of the present disclosure. The server computer device 901 may include, but is not limited to, the event detection and identification engine 230 (shown in FIG. 2), the database server 715, and the event detection and identification server 710 (both shown in FIG. 7). The server computer device 901 also includes a processor 905 for executing instructions. Instructions may be stored in a memory area 910. The processor 905 may include one or more processing units (e.g., in a multi-core configuration).

The processor 905 is operatively coupled to a communication interface 915 such that the server computer device 901 is capable of communicating with a remote device such as another server computer device 901, another event detection and identification server 710, or the client system 725 (shown in FIG. 7). For example, the communication interface 915 may receive requests from the client system 725 via the Internet, as illustrated in FIG. 7.

The processor 905 may also be operatively coupled to a storage device 934. The storage device 934 is any computer-operated hardware suitable for storing and/or retrieving data, such as, but not limited to, data associated with the database 720 (shown in FIG. 7). In some embodiments, the storage device 934 is integrated in the server computer device 901. For example, the server computer device 901 may include one or more hard disk drives as the storage device 934. In other embodiments, the storage device 934 is external to the server computer device 901 and may be accessed by a plurality of server computer devices 901. For example, the storage device 934 may include a storage area network (SAN), a network attached storage (NAS) system, and/or multiple storage units such as hard disks and/or solid state disks in a redundant array of inexpensive disks (RAID) configuration.

In some embodiments, the processor 905 is operatively coupled to the storage device 934 via a storage interface 920. The storage interface 920 is any component capable of providing the processor 905 with access to the storage device 934. The storage interface 920 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 905 with access to the storage device 934.

The processor 905 executes computer-executable instructions for implementing aspects of the disclosure. In some embodiments, the processor 905 is transformed into a special purpose microprocessor by executing computer-executable instructions or by otherwise being programmed. For example, the processor 905 is programmed with instructions such as illustrated in FIGS. 3 and 4.

At least one of the technical solutions provided by this system to the technical problems may include: (i) improved speed and accuracy in detecting events in a power grid; (ii) detecting rare events with little available data with improved accuracy; (iii) reducing the time and cost of building event detection and identification systems; (iv) reducing chances that an important event is not detected; (v) improving accuracy in determining which factors lead to different events; and (vi) potentially responding to events to prevent their occurrence.

The methods and systems described herein may be implemented using computer programming or engineering techniques including computer software, firmware, hardware, or any combination or subset thereof, wherein the technical effects may be achieved by performing at least one of the following steps: a) store a database including a plurality of categorized events, where each categorized event of the plurality of categorized events is associated with an event category; b) receive sensor data from a plurality of sensors monitoring a power grid, where the sensor data is received in real-time, and where the sensor data includes at least one of active power, reactive power, voltage, frequency, and phase angle; c) identify one or more features contained in the sensor data; e) compare the one or more features to the plurality of categorized events; f) determine an event category based on the comparison; g) adjust operation of the power grid based on the determined event category; h) compare the one or more features of each categorized event to the one or more features of the sensor data, where each categorized event of the plurality of categorized events includes one or more features; i) calculate a similarity value for each categorized event in comparison to the received sensor data; j) for each event category, calculate a probability that the received sensor data is associated with the corresponding event category; k) determine whether or not to add the received sensor data to the database as a categorized event; l) calculate an importance score for each event in the database; m) calculate an importance score for the received sensor data; n) compare the important score for the received sensor data to the importance score for every event in the determined event category; o) add the received sensor data to the database based on that comparison; and p) remove an event from the database based on that comparison.

In some other embodiments, the technical effects may be achieved by performing at least one of the following steps: a) store a database including a plurality of categorized events, wherein each categorized event of the plurality of categorized events is associated with an event category; b) receive an event, where the event includes at least one of active power, reactive power, voltage, frequency, and phase angle; c) identify one or more features contained in the event; d) compare the one or more features to the plurality of categorized events; e) determine an event category for the event based on the comparison; f) provide the determined event category to a user for confirmation; g) compare the one or more features of each categorized event to the one or more features of the sensor data, where each categorized event in the plurality of categorized events includes one or more features; h) calculate a similarity value for each categorized event in comparison to the event based on the comparison of the one or more features; i) for each event category, calculate a probability that the received event is associated with the corresponding event category based on the similarity values; j) determine whether or not to add the received event to the database as a categorized event; k) receive a plurality of events; l) for each event of the plurality of events, identify one or more features contained in the corresponding event; m) for each event of the plurality of events, compare the one or more features to the plurality of categorized events; n) for each event of the plurality of events, determine an event category for the corresponding event based on the comparison; o) for each event of the plurality of events, update the database with the corresponding event as a categorized event; p) retrieve, from the database, a plurality of events associated with a first event category; q) compare the plurality of events to each other; r) determine at least one event of the plurality of events to remove from the database; and s) remove the determined at least one event from the plurality of categorized events in the database.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing sensor data, and detecting abnormalities.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computing device for detecting and identifying power system events comprising at least one processor in communication with at least one memory device, wherein said at least one processor is programmed to:
store a database including a plurality of categorized events, wherein each categorized event of the plurality of categorized events is associated with an event category;
receive sensor data from a plurality of sensors monitoring a power grid;
identify one or more features contained in the sensor data;
compare the one or more features to the plurality of categorized events; and
determine an event category based on the comparison.

2. The computing device in accordance with claim 1, wherein said at least one processor is further programmed to adjust operation of the power grid based on the determined event category.

3. The computing device in accordance with claim 1, wherein the sensor data is received in real-time.

4. The computing device in accordance with claim 1, wherein the sensor data includes at least one of active power, reactive power, voltage, frequency, and phase angle.

5. The computing device in accordance with claim 1, wherein each categorized event of the plurality of categorized events includes one or more features, and wherein said at least one processor is further programmed to compare the one or more features of each categorized event to the one or more features of the sensor data.

6. The computing device in accordance with claim 1, wherein said at least one processor is further programmed to calculate a similarity value for each categorized event in comparison to the received sensor data.

7. The computing device in accordance with claim 6, wherein said at least one processor is further programmed to, for each event category, calculate a probability that the received sensor data is associated with the corresponding event category.

8. The computing device in accordance with claim 1, wherein said at least one processor is further programmed to determine whether or not to add the received sensor data to the database as a categorized event.

9. The computing device in accordance with claim 8, wherein the at least one processor is further programmed to:
calculate an importance score for each event in the database;
calculate an importance score for the received sensor data;
compare the important score for the received sensor data to the importance score for every event in the determined event category; and
add the received sensor data to the database based on that comparison.

10. The computing device in accordance with claim 9, wherein the at least one processor is further programmed to remove an event from the database based on that comparison.

11. A computing device for building a database of categorized events comprising at least one processor in communication with at least one memory device, wherein said at least one processor is programmed to:
store a database including a plurality of categorized events, wherein each categorized event of the plurality of categorized events is associated with an event category;
receive an event;
identify one or more features contained in the event;
compare the one or more features to the plurality of categorized events; and
determine an event category for the event based on the comparison.

12. The computing device in accordance with claim 11, wherein said at least one processor is further programmed to provide the determined event category to a user for confirmation.

13. The computing device in accordance with claim 11, wherein the event includes at least one of active power, reactive power, voltage, frequency, and phase angle.

14. The computing device in accordance with claim 11, wherein each categorized event of the plurality of categorized events includes one or more features, and wherein said at least one processor is further programmed to compare the one or more features of each categorized event to the one or more features of the sensor data.

15. The computing device in accordance with claim 14, wherein said at least one processor is further programmed to calculate a similarity value for each categorized event in comparison to the event based on the comparison of the one or more features.

16. The computing device in accordance with claim 15, wherein said at least one processor is further programmed to, for each event category, calculate a probability that the received event is associated with the corresponding event category based on the similarity value.

17. The computing device in accordance with claim 11, wherein said at least one processor is further programmed to determine whether or not to add the received event to the database as a categorized event.

18. The computing device in accordance with claim 17, wherein said at least one processor is further programmed to:
calculate an importance score for each event in the database;
calculate an importance score for the received sensor data;
compare the important score for the received sensor data to the importance score for every event in the determined event category; and
add the received sensor data to the database based on that comparison.

19. The computing device in accordance with claim 11, wherein said at least one processor is further programmed to:
receive a plurality of events;
for each event of the plurality of events, identify one or more features contained in the corresponding event;
for each event of the plurality of events, compare the one or more features to the plurality of categorized events;
for each event of the plurality of events, determine an event category for the corresponding event based on the comparison; and
for each event of the plurality of events, update the database with the corresponding event as a categorized event.

20. The computing device in accordance with claim 11, wherein said at least one processor is further programmed to:
retrieve, from the database, a plurality of events associated with a first event category;
compare the plurality of events to each other;
determine at least one event of the plurality of events to remove from the database; and
remove the determined at least one event from the plurality of categorized events in the database.
